(19) United States
(12) Patent Application Publication
(10) Pub. No.: US 2008/0112777 A1
(43) Pub. Date: May 15, 2008

(54) Educational folding toy and puzzle

(76) Inventor: Michael Watson, Kennesaw, GA (US)

Correspondence Address: Michael Watson, 231 Dillard Drive, Kennesaw, GA, 30144, US

(21) Appl. No.: 11/983,276

(22) Filed: Nov. 8, 2007

Related U.S. Application Data
(60) Provisional application No. 60/858,160, filed on Nov. 10, 2006.

(51) Int. Cl. B23P 11/00; B26D 3/12; B42C 9/00

(52) U.S. Cl. 412/8; 29/428; 83/49

(57) ABSTRACT

The present invention is an educational toy and puzzle. The user of the invention is given multiple patterns, preferably paper patterns. Each pattern can be assembled into a box and then each box may be connected or interlocked, with the resulting combination of blocks producing a specific result, while at the same time will allowing the user to creative. In doing so they the user, likely a child, will sharpen their own problem solving skills all while learning hand-eye-coordination and dexterity in a fun and unique new way. In the most basic terms the invention can be characterized as building blocks. Building blocks that when interlocked or connected with additional such blocks build an overall image, design or series of words on the surface by adjoining the blocks side by side, as one would typically place puzzle pieces side by side, so as to create the desired resulting display configuration.

### CROSS-REFERENCE TO RELATED APPLICATIONS

This application claims the benefit of earlier priority as a result of a provisional patent application (60/858,160) that was filed on Nov. 10, 2006.

### BACKGROUND OF THE INVENTION

1. Field of the Invention

This invention relates generally to an educational folding toy and puzzle.

2. Background

Currently there are a number of solutions for educational toys and puzzles. Some of these solutions attempt to assert themselves as educational toys but these solutions fail to meet the needs of the industry because they simply do not push the end-user to strive for a new experience and in turn educate themselves. Other solutions attempt to urge the users to develop and refine new skill sets but these solutions are similarly unable to meet the need of the industry because they don't engage their audience enough to hold their attention before they put the item down. Still other solutions seek to achieve education through creativity but these solutions also fail to meet the needs of their industry because they don't provide their customers with the proper tools to achieve by using truly creative measures which would allow the customer to learn new experiences through creativity.

### SUMMARY OF THE INVENTION

The present invention advantageously fills the aforementioned deficiencies by providing an educational folding toy and puzzle that provides a brand new kind of building block and set of blocks that can be connected as a three-dimensional puzzle. In the most basic terms the invention can be characterized as building blocks. As an educational toy, children will interact with these blocks to learn their ABC's in a fun and unique new way. Preferably designed with 36 pages (including 26 letters and 10 numerals) children will work on one letter at a time, allowing time to focus on each individual character as they color and subsequently fold every page of the book into 36 separate blocks.

Every page once folded forms a six sided block, four of which have content, which can include, among other things: an uppercase letter, a lowercase letter, a playful letter (which is the puzzle side) and a sign equivalent (American Sign Language) for each of the 26 letters. Children can first learn to spell words by interlocking blocks together next they can form sentences by inserting spaces and again by interlocking these blocks. Finally they will solve the puzzle to learn the proper order of their ABC's.

The invention is not limited to blocks that can assist in the learning of ABCs, as described in the previous paragraphs. The same six sided block structure can also be used much like a coloring book would be used, with images appearing on the flat pages to be colored or even simply pre-printed material that could be used as clues in solving a puzzle. In this version of the present invention when the blocks are formed (preferably after coloring has taken place) the blocks can be arranged side by side and top to bottom to create an overall image or picture. Therefore, each side of the block would be akin to a piece of a puzzle.

As an entertainment/educational toy, children can interact with these blocks in a fun and unique new way. Beginning by coloring flat pages that will fold to create separate blocks each of which have four “fragmented” images, one on each side of the block. As time passes and they get tired of the mural they can disassemble and reassemble the fragments into a new mural. The children can continue this until they have completed all of the different murals.

The educational aspect of this piece is in the skill set required to produce each mural. As the children color the four fragments on each of the 36 pages they will have to associate each fragment of the puzzle with the larger whole so that as they color the colors are consistent across all the pieces. Additionally the skills required for properly folding these blocks teach them dexterity and improve hand-to-eye-coordination.

Each piece can be converted from a flat sheet to a single block by following the folding techniques outlined below. A block is created by working with an individual flat sheet placed in landscape orientation and then by folding each center panel in a horizontal manner working from right to left at a 90 degree angle along each of the vertical scores. At the same time you are folding from right to left you also fold the top and bottom panels again at 90 degrees this time along the horizontal scores until you have created a completely enclosed six sided box. The final step is to ensure the box is “locked” closed which is achieved by using the panel(s) on the fifth column as a latching mechanism.

Each piece is created from one component that is a sheet of paper, or similar material (such as poster board, newspaper, cardboard, plastic, recycled materials, etc.) that utilizes a series of cuts and folds to achieve a desired outcome. The material is divided up using a series of cuts and folds into three rows and five columns that when folded using 90 degree angles will yield one block. These blocks can be connected in a horizontal manner so that they can then create a wider structure made up of multiple blocks. Additionally they can be connected in a vertical manner again to achieve tall structure made up of multiple blocks. Even further they can be concurrently connected both horizontally as well as vertically to achieve a larger overall structure, which can with enough horizontal and vertical blocks make up a wall or barrier.

The best way to make this invention is by printing a series of different images on one side of the different sheets, then applying a diecut which will trim every sheet to a predetermined size all while applying six scores (two horizontally and four vertically) and eight cuts (all vertically) exactly the same on every sheet. Although 36 sheets are used in this example, the number of sheets can indeed vary and any number of sheets and pages can be used. After the diecut the sheets will be collated and packaged together in a flat form. The purpose of the six scores and eight cuts are to create three rows and five columns on every sheet which will become the 15 panels that are required to fold each of the blocks. Four of the columns provide the first four sides of the six-sided blocks while the fifth column acts as a latching mechanism to hold each individual block together. The 1^{st} and 3^{rd} or top and bottom rows provide the remaining two faces of each block. An additional option is that the 36 pages could be bound together using anyone of several conventional book-binding methods (perfect-binding, tape binding, wire-o binding, spiral binding, velo binding, etc.) which would allow the pages to hold together in a cohesive book which the user could color like a conventional coloring book until they are ready to tear out each page, along a perforated line, to fold into a block.

It is therefore an object of the present invention to assist children in learning their ABC's in a fun hands-on way as well as teaching them sign language by transforming a static coloring book into an interactive 3D mural. It assists children with problem solving, coordination, dexterity and teaches them to explore and be creativity.

It is a further object of the present invention to turn a 2D coloring book into a 3D puzzle. It transforms a static coloring book into an interactive 3D mural. It assists children with problem solving, coordination, dexterity and teaches them to explore and be creativity.

It is still a further object of the present invention to allow for the creation of a three-dimensional object, such as a castle for example, from a flat 2D book.

Further still, it is an object of the present invention to improve one's problem solving skills, improve one's dexterity, deliver a reward through a sense of achievement, instill a sense of creativity, assist in the learning of the alphabet, assist in learning how to spell and assist in developing three-dimensional spatial skills.

Finally, it is an object of the present invention to provide an educational folding toy and puzzle that does not suffer from any of the problems or deficiencies associated with prior solutions.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1A depicts the front side of an individual sheet in vertical view as the viewer would read it.

FIG. 1B depicts the back side of an individual sheet in a horizontal view as the viewer would fold it. Here you can easily see the three rows and five columns.

FIG. 1C depicts the folding of an individual sheet to form a single block.

FIG. 1D depicts the next stage of folding an individual sheet to form a single block.

FIG. 1E depicts the next stage of folding an individual sheet to form a single block from a top angle.

FIG. 1F depicts the same stage as FIG. 1e of folding an individual sheet to form a single block from a bottom angle.

FIG. 1G depicts one completed block.

FIG. 1H depicts two completed blocks preparing to interlock.

FIG. 1I depicts two completed blocks twisting together to interlock.

FIG. 1J depicts two completed blocks interlocked together.

FIG. 1K is a combined shot of all the separate elements contained within this patent, including the puzzle element, as they only apply to the first product.

FIG. 1L is a combined shot of all the separate elements contained within this patent, including the puzzle element, as they only apply to the second product.

FIG. 2A depicts the first panel of the castle opening.

FIG. 2B depicts the next two panels opening.

FIG. 2C depicts the next four panels opening.

FIG. 2D depicts the next four panels opening further.

FIG. 2E depicts the next four panels opening further.

FIG. 2F depicts the next group of attached panels opening.

FIG. 2G depicts the interior of the book in addition to the next group of panels closing.

FIG. 2H depicts the four panels that create the top of the castle

FIG. 2I depicts the four panels that create the bottom of the castle.

FIG. 2J depicts the four sides of the castle coming together.

FIG. 2K depicts further the four sides of the castle coming together.

FIG. 2L depicts the latching mechanism coming together.

FIG. 2M depicts the castle in it's finished state.

FIG. 2N depicts the top of the castle.

FIG. 2O depicts the bottom of the castle.

FIG. 3A depicts how two A2s from FIG. 1 create the book depicted in FIG. 2. This is meant to illustrate the commonality of FIG. 1 and FIG. 2

FIG. 3B depicts the commonality of FIG. 1's book and FIG. 2's book.

FIG. 3C depicts the form used in FIG. 2.

FIG. 4A depicts the form used in FIG. 2.

FIG. 4B depicts an alternative method for creating FIG. 2

FIG. 4C depicts another alternative method for creating FIG. 2

FIG. 5A depicts an alternative method for folding FIG. 2

FIG. 5B depicts the form coming together to create the box

FIG. 5C depicts the form closing tighter to create the box.

FIG. 5D depicts the form in a more basic form—a basic box.

FIG. 6A depicts a technique for stacking vertically, multiple boxes and interlocking them.

FIG. 6B depicts a stack of four boxes interlocked vertically.

FIG. 7A depicts the first castle folding one panel behind another to allow for a place for the second castle to interlock.

FIG. 7B depicts the first castle closing together.

FIG. 7C depicts the first castle in a closed state.

FIG. 7D depicts the second castle preparing to interlock with the first castle.

FIG. 7E depicts the second castle locking into the first castle

FIG. 7F depicts further the second castle locking into the first.

FIG. 7G depicts the two castles locked together to create a larger horizontal castle.

### DETAILED DESCRIPTION OF THE INVENTION

The present invention is directed to educational folding toy and puzzle. Each piece is created from one component that is a sheet of paper, or similar material (such as poster board, newspaper, cardboard, plastic, recycled materials) that utilizes a series of cuts and folds to achieve a desired outcome. The material is preferably divided up using a series of cuts and folds (scores) into three rows and five columns which equal a total of 15 individual panels per sheet that when folded using 90 degree angles will yield one block. Additionally once the blocks have been created they can be interlocked or connected.

Of the single component (i.e., one sheet or unit of whatever material is selected) it is in fact the 15 individual panels that provide the function for this piece. Four panels will preferably have content to color, they are preferably located in the center of the sheet or rather the 2^{nd} row. At the beginning the user is preferably instructed to color these four panels. After coloring has finished, the user will fold the pieces together along the 5 columns at 90 degree angles while at the same time folding in the 1^{st} row and 3^{rd} row, again at 90 degree angles to form a basic block. The purpose of the 1^{st} and 3^{rd} rows are to provide the block with the ability to hold together.

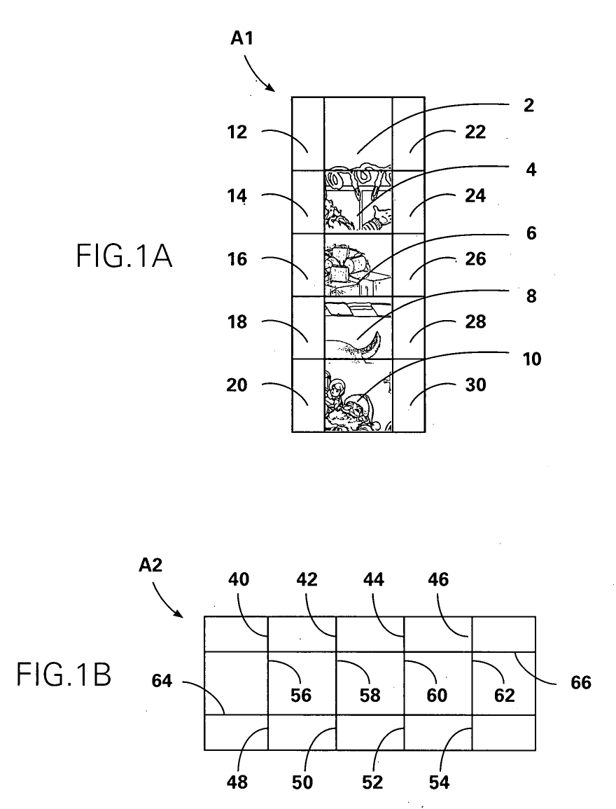

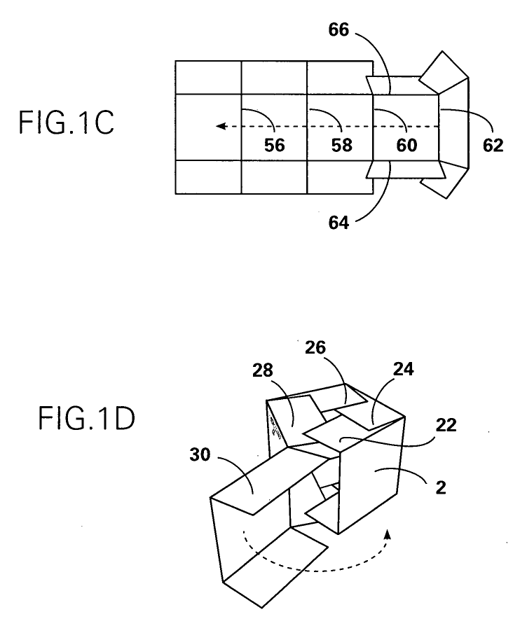

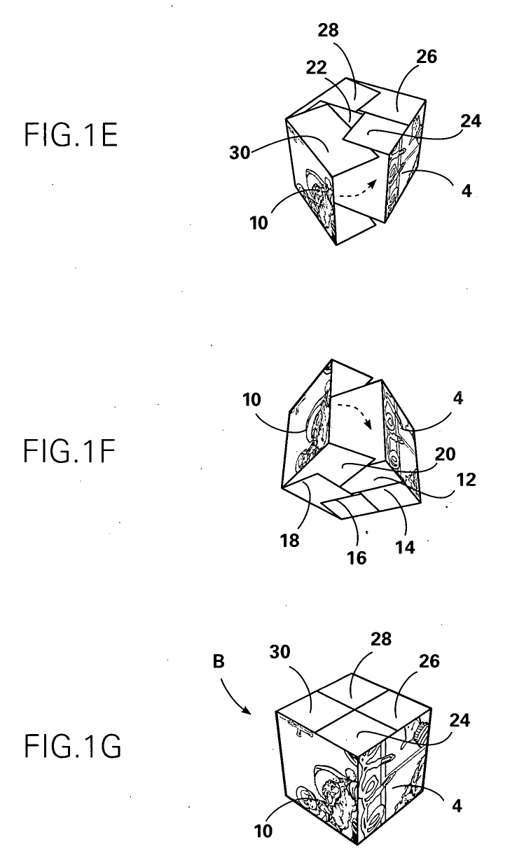

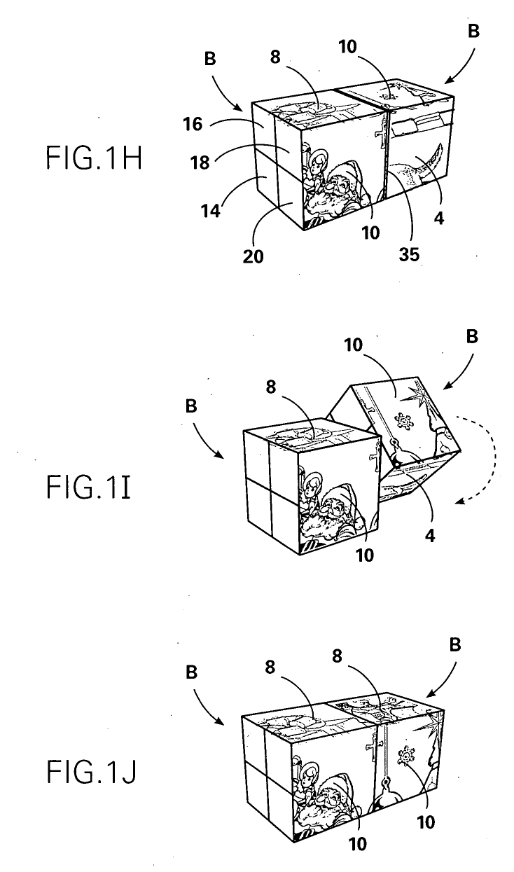

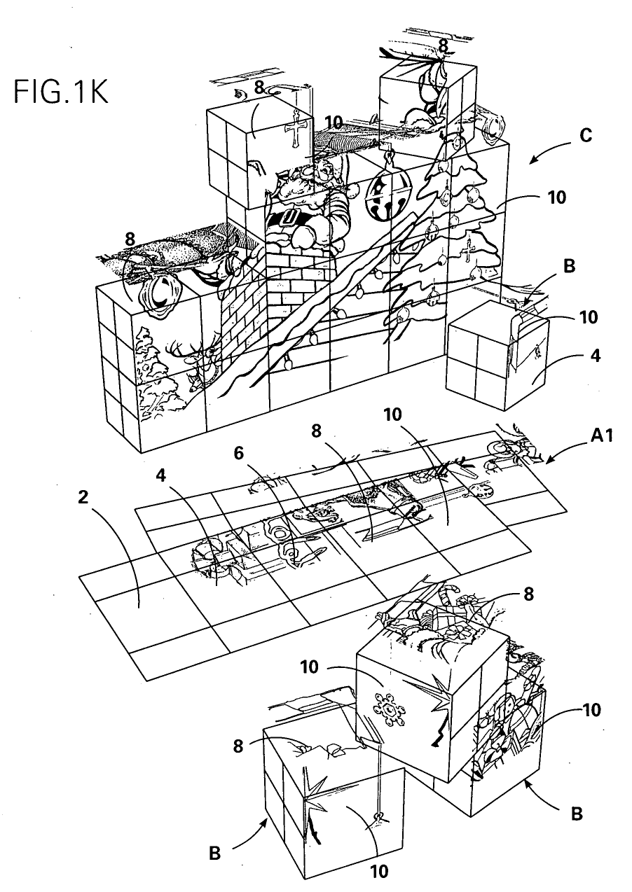

FIG. 1A depicts the front side of an individual sheet in a vertical view as the viewer would read it. A1 is a the front side of an individual sheet which is divided into 15 separate panels which are comprised of a series of five separate left flaps: 12, 14, 16, 18 and 20; five middle panels: 2, 4, 6, 8 and 10; and finally a series of five separate right flaps: 22, 24, 26, 28 and 30.

FIG. 1B depicts the back side of FIG. 1A in a horizontal view as the viewer would fold it. Here you can readily see the five columns and three rows. A2 is the back side of an individual sheet with the top of the sheet on the right side and the bottom of the sheet on the left side. There are two of horizontal scores: 64 and 66 and four vertical scores: 56, 58, 60 and 62. While 48, 50, 52 and 54 depict cuts that create the five left flaps: 12, 14, 16, 18 and 20. The five right flaps: 22, 24, 26, 28 and 30 are created from cuts: 40, 42, 44 and 46.

FIG. 1C depicts the folding of an individual sheet to form a single block. Working from the back side of the sheet A2 the user will fold from the right working towards the left along the horizontal scores: 64 and 66 in addition to all the vertical scores: 56, 58, 60 and 62.

FIG. 1D depicts the next stage of folding an individual sheet to form a single block. As the user is folding the piece flap 22 on the top should be placed underneath flap 24, 24 should be placed under 26 and 26 should be placed under 28.

FIG. 1E depicts the next stage of folding an individual sheet to form a single block from a top angle. As the block comes to a close flap 30 should be on top of flap 22 but underneath flap 24.

FIG. 1F depicts the same stage as FIG. 1e of folding an individual sheet to form a single block from a bottom angle. From the bottom perspective flap 12 should be on top of flap 14, flap 14 should be on top of flap 16, 16 should be on top of 18, 18 should be on top of 20 and 20 should be on top of 12.

FIG. 1G depicts one completed block. B illustrates a single completed block in which flap 30 is resting above 28, 28 is resting above 26, 26 is resting above 24 and 24 is resting above 30.

FIG. 1H, FIG. 1I and FIG. 1J all relate to the situation where two or more blocks will be connected or interlocked. Specifically, FIG. 1H shows the invention with the left flaps: 14, 16, 18 and 20 of block B facing your left and the right flaps of the second block B facing your right pull them apart ever so slightly 35. The facade fragment 10 of the left block should be facing you while the top façade fragment 10 of the right block faces up.

FIG. 1I depicts two completed blocks B twisting together to interlock. Rotate the block on the right 90 degrees towards you or inversely rotate the block on the left 90 degrees away from you. You can repeat this step as many times as you like by adding additional blocks to the right or left.

FIG. 1J depicts two completed blocks interlocked together. After you have rotated the two blocks B the two facades 10 align with each as does the other three sides 8, 6, and 4 of the blocks which begin to form a greater meaning.

FIGS. 1K and 1L are an overview of all pieces and depict how multiple blocks are connected so as to bring together the pieces of a puzzle to depict some type of image, saying or graphic as a mural which is represented here as C.

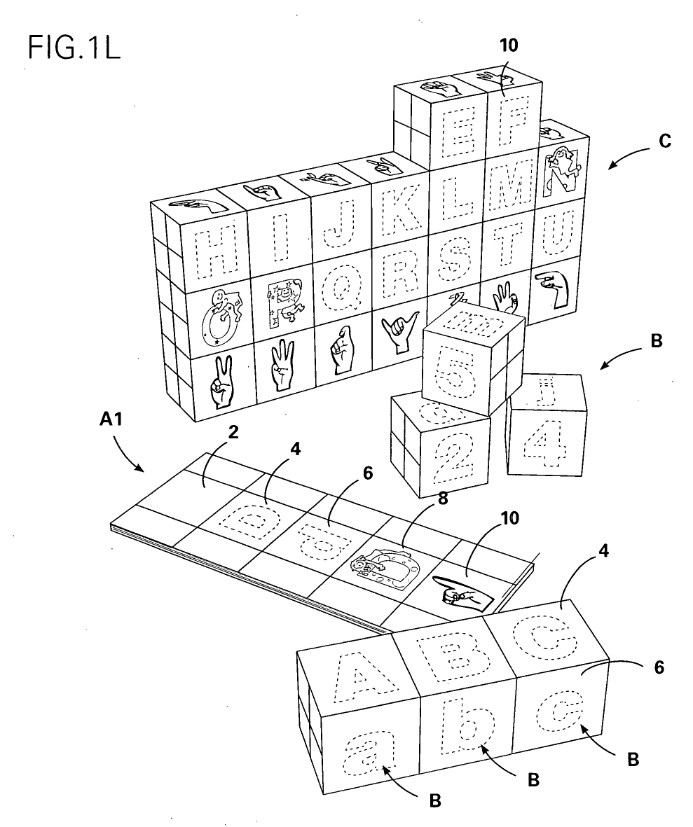

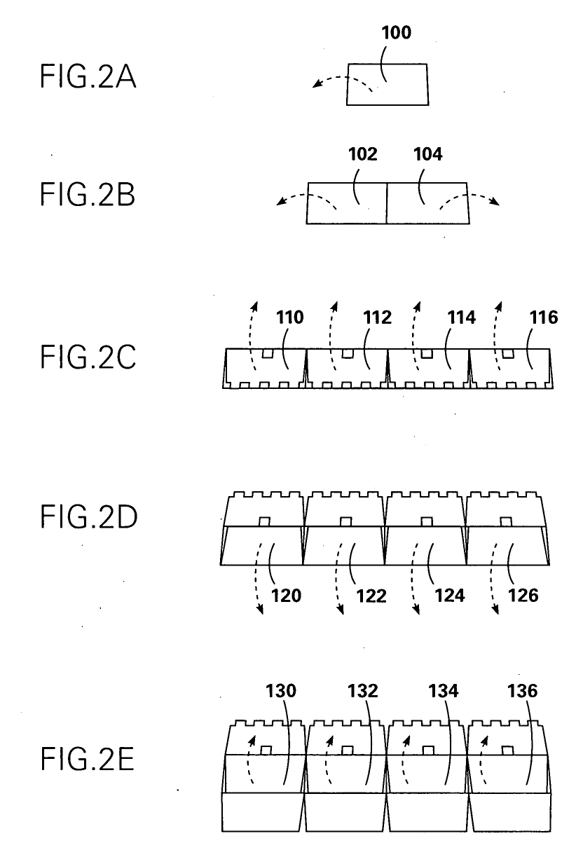

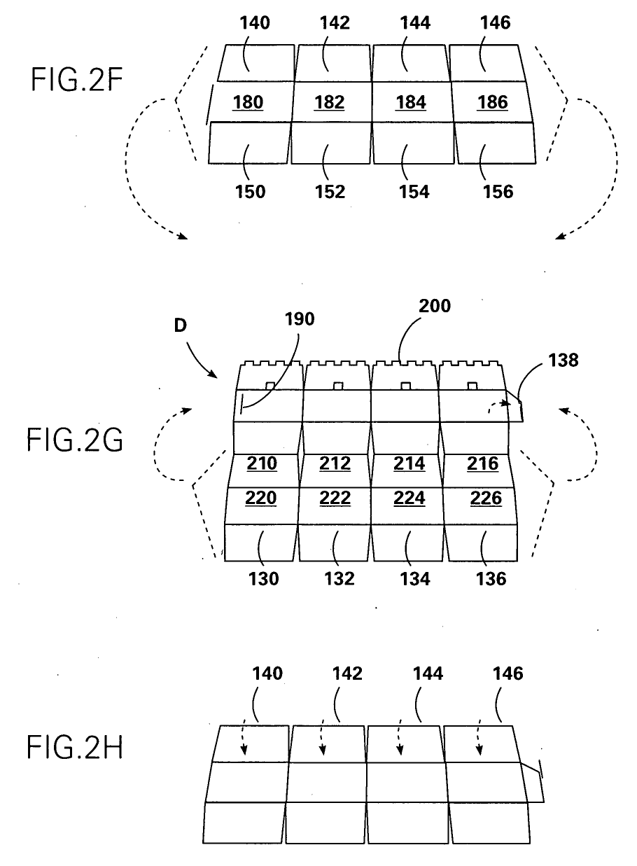

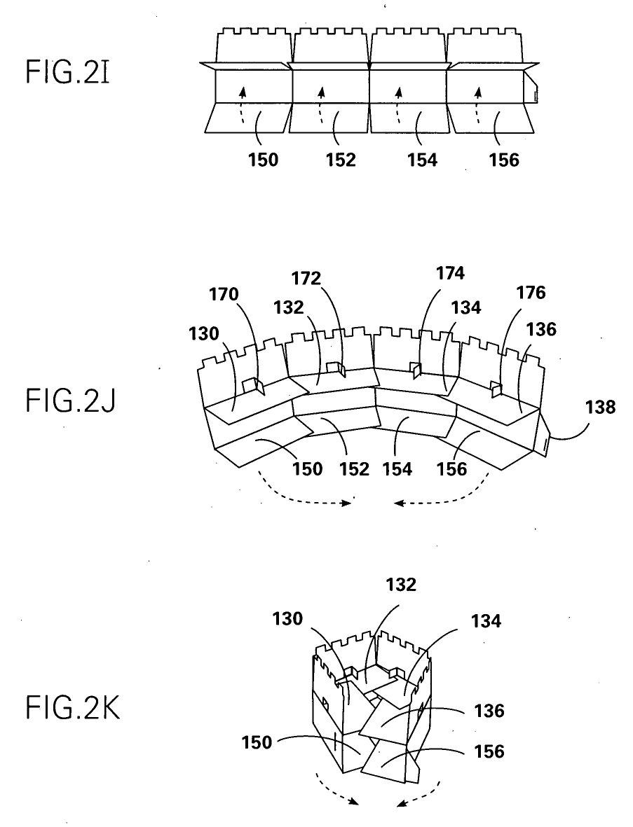

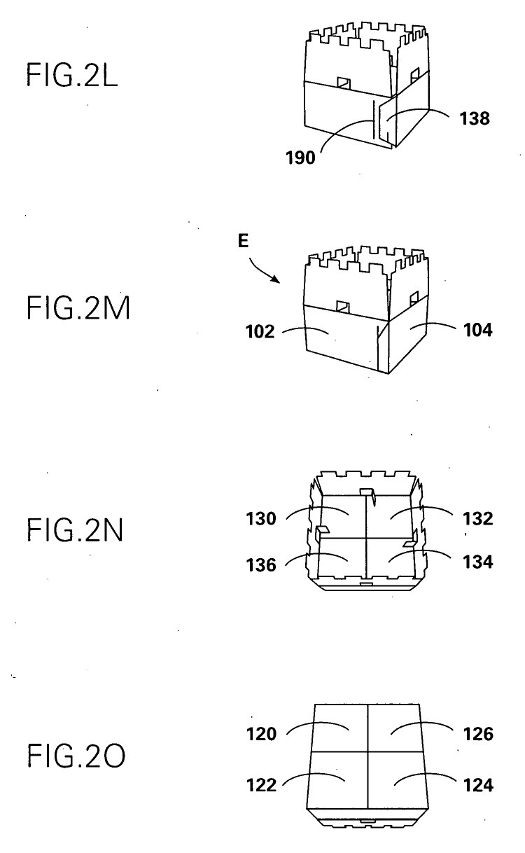

FIG. 2A depicts an alternate version of the book in FIG. 1 represented here in closed form with 100 being the cover.

FIG. 2B depicts panel 102 opening to the left 180 degrees while page 104 opens to the right 180 degrees.

FIG. 2C depicts panels 110, 112, 114 and 116 opening upward 180 degrees.

FIG. 2D depicts panels 120, 122, 124 and 126 opening downward 180 degrees.

FIG. 2E depicts panels 130, 132, 134 and 136 opening upward 180 degrees.

FIG. 2F depicts panels 140, 142, 144, 146, 180, 182, 184, 186, 150, 152, 154 and 156 opening downward 180 degrees as one large group.

FIG. 2G Reference D depicts the entire “book” as the user would view it when displayed as an open, flat sheet. In this example 200 represents the optional battlements (a parapet at the top of a wall, usually of a fort or castle). Additionally panel 138 opens to the right 180 degrees, which will later be used as a locking mechanism. 190 is the slit in which panel 138 inserts to lock. In it's completely open and flat form this “book” is comprised of five columns (four columns are used for graphics and one column for the tabbed locking mechanism) and six rows creating a total of twenty five panels, each of which play a vital role in the functionality of this “book.” D also represents the bottom twelve panels: 210, 212, 214, 216, 220, 222, 224, 226, 130, 132, 134 and 136 folding upward 180 degrees again as one large group.

FIG. 2H depicts panels 140, 142, 144 and 146 folding downwards 90 degrees.

FIG. 2I depicts panel 150, 152, 154 and 156 folding upwards 90 degrees.

FIG. 2J depicts the panels of the book starting to enclose. This is achieved by overlapping panels. On the top row panel 130 goes over panel 132, 132 over 134 and 134 over 136, while on the bottom row panel 150 goes over panel 152, 152 over 154 and 154 over 156. 170, 172, 174 and 176 are optional flaps that open to assist the vertical panels to remain vertical.

FIG. 2K depicts panel 156 on the bottom row overlapping panel 150 and 136 on the top row overlapping 130.

FIG. 2L depicts tab 138 inserting into the slit 190

FIG. 2M depicts the book in it's completed 3-D model form. In this example the completed form is a castle, however this form is by no means limited to a castle. This form could just as easily be bricks to create a house or a framework to create a space station or even architectural blocks to create buildings in a city. This is no more than a representation of the possibilities this form can embody.

FIG. 2N depicts the top of the castle in which panel 130 is on top of panel 132, panel 132 is on top of 134, 134 is on top of 136 and 136 is on top of 130.

FIG. 2O depicts the bottom view of the castle in which panel 120 is on top of panel 126, panel 126 is on top of 124, 124 is on top of 122 and 122 is on top of 120.

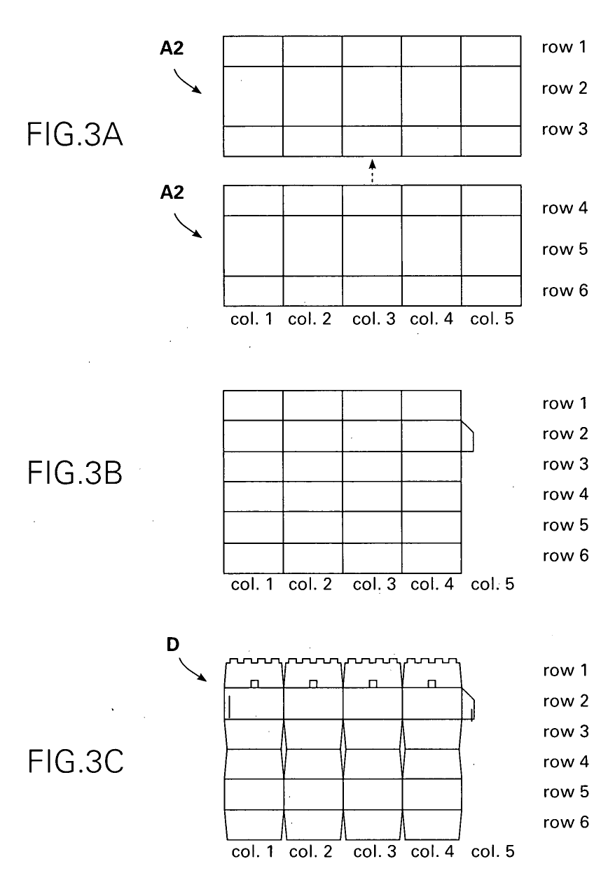

FIG. 3A depicts two A2 sheets coming together to create D in FIG. 3C. Each A2 sheet is comprised of five columns and three rows.

FIG. 3B is a transitional example of two A2 sheets combined with the sizes of the panels redefined to create a single sheet which now has five columns and six rows. In this example the fifth column has been converted to a tab.

FIG. 3C is sheet D in final flat form which displays the preferred diecut. Certain pieces of material have been removed so that when it's folded down the material the panels are created from will not buckle which will create a neatly folded book.

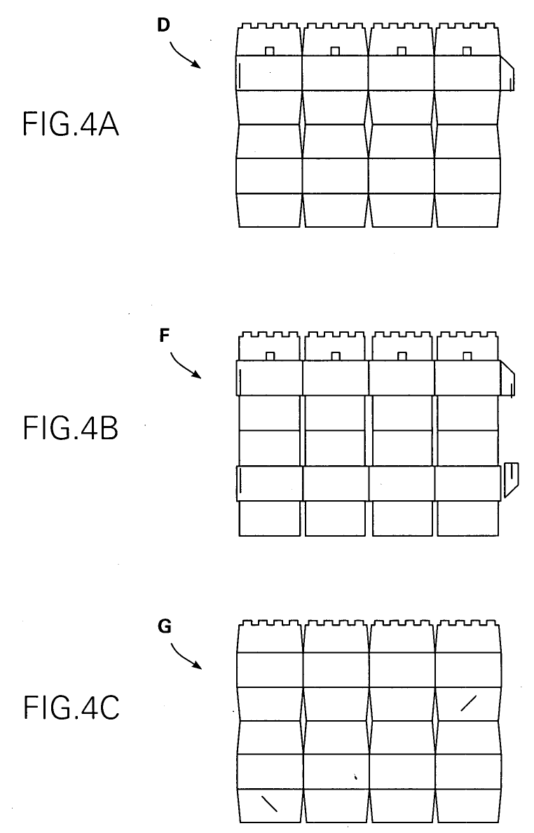

FIG. 4A depicts the flat sheet D as first seen in FIG. 2G.

FIG. 4B depicts an alternative method for creating the flat sheet D. F uses the same base form as D (five columns and six rows) but has replaced the removed angled pieces of material with squared off pieces. Additionally a bottom tab and slit have been added.

FIG. 4C again depicts an alternative method for creating the flat sheet D. G uses the same base form as D (five columns and six rows) but has removed the tab as the locking mechanism and replaced it with slits in which when folded the individual panels can, slide into. In short there are a number of ways this form can be created, with only several examples displayed here. What is important is the overall form as a whole and not the minor details that alter the specifics of the form which included items like the tabbed latching mechanism, the battlements, the small flaps that open on the top and all the various possibilities of altering the diecut to optimize the method of folding down the flat sheet to it's closed state.

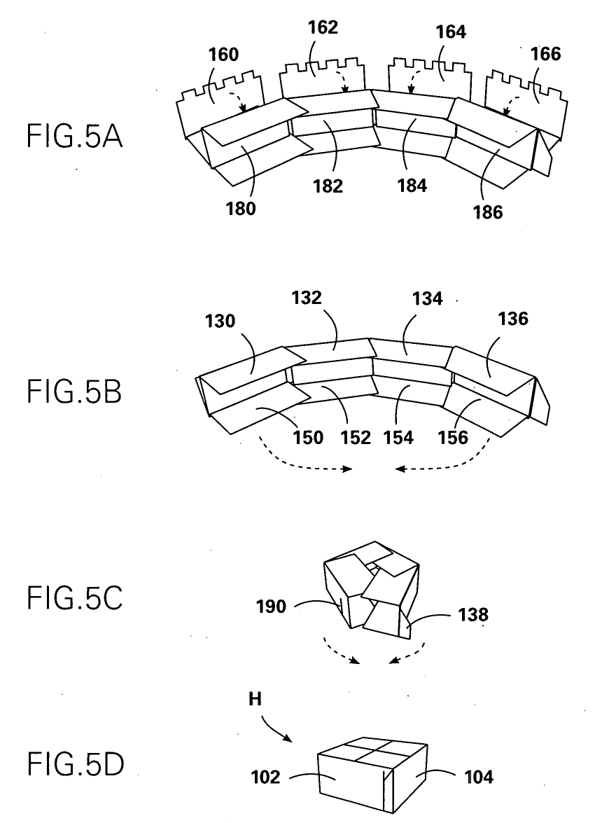

FIG. 5A depicts a different method of folding the book that allows the user to “hide” the battlements by folding them into the book which in turn creates a simpler box. Fold panel 160, 162, 164 and 166 behind panels 180, 182, 184 and 186.

FIG. 5B depicts the book coming together as a box. This again is achieved by overlapping panels. On the top row panel 130 goes over panel 132, 132 over 134 and 134 over 136, while on the bottom row panel 150 goes over panel 152, 152 over 154 and 154 over 156.

FIG. 5C depicts the box enclosing where 138 will be inserted into 190.

FIG. 5D depicts the finished box in it's simpler form.

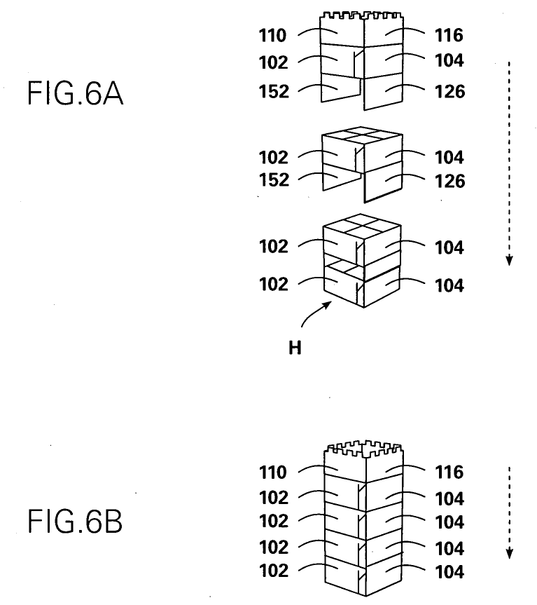

FIG. 6A depicts a method of locking multiple boxes together in a vertical manner to create a taller structure. The basic method of folding for the top piece remains the same as FIG. 2 except panels 122 and 126 should be left “hanging” down. For the second and third boxes the method of folding used in FIG. 5 is used, again leaving panels 122 and 126 hanging down. For the bottom box or base the technique used in FIG. 5 is applied to construct the box. As the boxes begin to stack on top of one another all 152 panels should be inserted in the gap in front of 100 while all the 126 panels should be inserted in the small gap behind the 104 panels.

FIG. 6B depicts the completed tower structure.

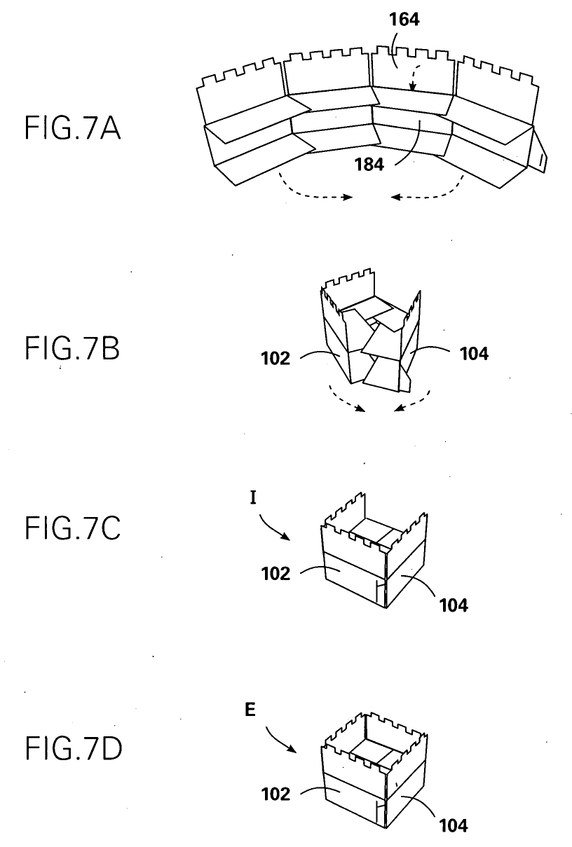

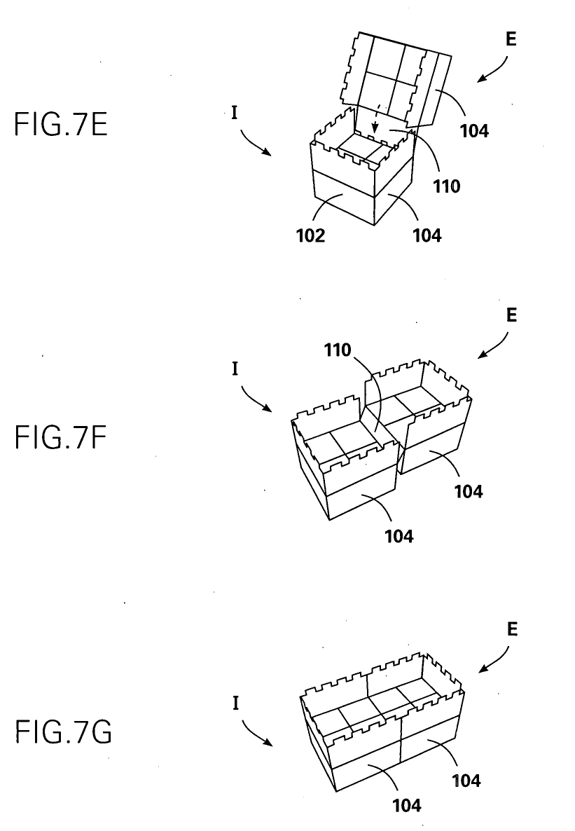

FIG. 7A depicts a method for locking two boxes together to act as one longer box. On the first castle use the same folding technique show in FIG. 2 except panel 164 will be inserted behind panel 184 when closing the castle.

FIG. 7B depicts the castle closing.

FIG. 7C depicts the finished castle I which has one of the battlements (panel 164) hidden.

FIG. 7D depicts a second castle which has already been folded using the standard method shown in FIG. 2

FIG. 7E depicts the two castles beginning to lock together by inserting panel 110 on E behind the gap in panel 106 on I.

FIG. 7F again shows panel 110 further being inserted into I.

FIG. 7G depicts the two castles locked together as one bigger castle. This technique can be used over and over again to create many different shapes. Furthermore this folding technique can be used in conjunction with the folding techniques displayed in FIG. 2, FIG. 5 and FIG. 6 to create many new and exciting creations.

Alternatively, the present invention can be formatted as a single flat book that unfolds to erect a self-contained structure, such as but not limited to a castle. Additionally by combining multiples you can continue to build even more castles, or a village. Once a user has mastered the art of folding the first castle then they can exercise this new skill set by building and interlocking additional castles together. In this step the user is free to create as many different castles as the kit can create. In this manner you can create many different shapes by experimenting and combing multiple books. Since not everyone can build something as complicated as a 3D model from scratch, this toy fills that void, it provides the pre-fabricated components of a castle, that when assembled, enables the user to build a 3D castle on their own resulting in pride and self-confidence.

The castle is a single component that is one sheet of paper, or similar material, such as poster board, newspaper, cardboard, plastic, recycled materials, etc. which is divided up using a series of cuts and folds into 4 columns and 6 rows which equal a total of 24 individual panels plus one additional column for a latch which is presented to the user in a folded down shape that resembles a small book. Of course, there is no magic to the number of panels, and the panels can number more than or less than 24, although 24 plus the latch is preferred.

The best way to make the castle is by printing on one or both sides of a single sheet, then applying a diecut which will trim every sheet to a predetermined size all while applying a series of scores and cuts. After the diecut the sheets will be folded down into a book and packaged in kits of varying amounts. The diecut is to elaborate to describe in writing alone as such a reference to the patent drawings is mandatory to understand what is required of the diecut. Please see FIG. 3C of the patent drawings for a detail of the diecut.

The simplest way to make this product is by printing on one or both sides of a single sheet, or not printing at all, then applying a diecut to the sheet of paper or similar material (magnetic paper, plastic, thin foam, cardboard, etc.) which will then trim every sheet to a predetermined size all while applying a series of scores and cuts. After the diecut the sheets could opt not to be folded down into a book and opt to sell as flat sheets.

The battlement (200), which is the decorative element on the top of the castle, may be removed and replaced with other unique decorative elements. Furthermore, some or all of the flaps on the interior view (FIG. 2J: 170, 172, 174 and 176) can be removed, replaced or altered. Similarly, the latch (FIG. 2G: 138) can be removed, replaced or altered. Even further the slit (FIG. 2G 190) can be replaced, removed or altered.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A method of making an educational toy and puzzle comprising the steps of:
obtaining a plurality of sheets;
applying a diecut which will trim the plurality of sheets to a predetermined size while also applying six scores and eight cuts to create a first, middle and third row and five columns on each of the plurality of sheets to create 15 boxes on each of the plurality of sheets;
collating and packing the sheets together in a flat form.

2. The method of claim 1 wherein the plurality of sheets are made of paper, poster board, newspaper, cardboard, plastic or recycled materials.

3. The method of claim 2 further comprising the step of placing an image onto at least one of the boxes.

4. The method of claim 3 wherein the at least one image is placed on at least one box of the middle row.

5. The method of claim 4 wherein the at least one of the at least one images is a line art image.

6. The method of claim 5 further comprising the step of coloring the line art images.

7. The method of claim 6 wherein the coloring step is accomplished using crayons, colored pencils, markers, ink or paint.

8. The method of claim 7 further comprising the step of folding at 90 degrees along each score and each cut.

9. The method of claim 8 further comprising the step of folding and locking a single sheet into a block by working from right to left in a horizontal orientation along the middle row while at the same time folding the first and third rows beginning on the right underneath the first and third rows to the immediate left for the four rightmost columns after which the rightmost column's first and third rows are placed on top of the second leftmost column's first and third rows and finally the leftmost column's first row is placed underneath the second rightmost columns first row while the remaining third row is placed above the second leftmost column's third row.

10. The method of claim 9 further comprising the step of locking two or more blocks together by facing the first rows towards the left and the third rows towards the right is accomplished by rotating the block on the right 90 degrees clockwise or by rotating the block on the left 90 degrees counterclockwise thus intertwining the first and third rows which consequently locks the blocks together.

11. The method of claim 10 further comprising the step of binding together the plurality of sheets.

12. The method of claim 11 wherein the binding step secures the plurality of sheets together through conventional book-binding methods.

13. The method of claim 12 wherein the convention book binding methods are perfect-binding, tape binding, wire-o binding, spiral binding or velo binding.
